(19) United States
(12) Patent Application Publication
(10) Pub. No.: US 2014/0229070 A1
(43) Pub. Date: Aug. 14, 2014

(54) TRAILER REVERSE ASSIST CONTROL

(71) Applicant: GM GLOBAL TECHNOLOGY OPERATIONS LLC, Detroit, MI (US)

(72) Inventor: Daniel F. Witting, Sterling Heights, MI (US)

(73) Assignee: GM GLOBAL TECHNOLOGY OPERATIONS LLC, Detroit, MI (US)

(21) Appl. No.: 13/765,122

(22) Filed: Feb. 12, 2013

(51) Int. Cl. B62D 13/06

(52) U.S. Cl. CPC B62D 13/06
USPC 701/42

(57) ABSTRACT

A trailer reverse assist system for a vehicle coupled to a trailer is provided. The trailer reverse assist system includes a park assist controller configured to receive a distance input from at least one rear distance sensor. The park assist controller is configured to determine a pitch angle of the trailer relative to the vehicle based on the distance input. An electronic power steering system is coupled to the park assist controller. The electronic power steering system is configured to adjust a hand wheel angle of the vehicle based on the pitch angle of the trailer.

### FIELD OF THE INVENTION

Exemplary embodiments of the invention relate to a reverse assist system for a vehicle and, more particularly, to a trailer reverse assist control.

### BACKGROUND

Steering a vehicle coupled to a trailer in reverse may be challenging for some individuals. Incorrectly guiding a trailer in reverse may result in damage to the trailer or an object coupled to the trailer as well as to other structures. Park assist systems are used to indicate obstacles located in front of or behind a vehicle during parking. For example, some types of park assist systems include an imaging device such as a camera that is mounted to a front portion or a rear portion of the vehicle. The camera acquires image data that represents a viewable area either in front of or behind the vehicle. The park assist system may then provide visual or audio feedback to the driver to indicate how to maneuver the vehicle into a desired position.

When the vehicle is coupled to a trailer, maneuvering the vehicle in reverse is typically more difficult. As the vehicle is driven in reverse, a “rear drive” effect can cause the trailer to turn off course and not stay on an intended path desired by a driver. Additionally, park assist systems may not function as intended if the trailer itself is detected as an obstacle. Accordingly, it is desirable to provide an improved park assist system which exhibits improved performance from the standpoint of ease of use and convenience to the driver of a vehicle when operated in reverse while coupled to a trailer.

### SUMMARY OF THE INVENTION

In one exemplary embodiment of the invention, a trailer reverse assist system for a vehicle coupled to a trailer is provided. The trailer reverse assist system includes a park assist controller configured to receive a distance input from at least one rear distance sensor. The park assist controller is configured to determine a pitch angle of the trailer relative to the vehicle based on the distance input. An electronic power steering system is coupled to the park assist controller. The electronic power steering system is configured to adjust a hand wheel angle of the vehicle based on the pitch angle of the trailer.

In another exemplary embodiment of the invention, a method for trailer reverse assist for a vehicle coupled to a trailer is provided. A park assist controller receives a distance input from at least one rear distance sensor. The park assist controller determines a pitch angle of the trailer relative to the vehicle based on the distance input. The pitch angle of the trailer and a hand wheel angle of the vehicle are provided to an electronic power steering system. The electronic power steering system adjusts the hand wheel angle of the vehicle based on the pitch angle of the trailer.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is an illustration of an exemplary trailer reverse assist system in a vehicle;

FIG. 2 is an illustration of a display system for the trailer reverse assist system of FIG. 1;

FIG. 3 is a dataflow diagram illustrating a control system of the trailer reverse assist system of FIG. 1; and

FIG. 4 is a process flow diagram illustrating one embodiment of a method that may be performed in the trailer reverse assist system of FIG. 1.

### DESCRIPTION OF THE EMBODIMENTS

The following description is merely exemplary in nature and is not intended to limit the present disclosure, its application or uses. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

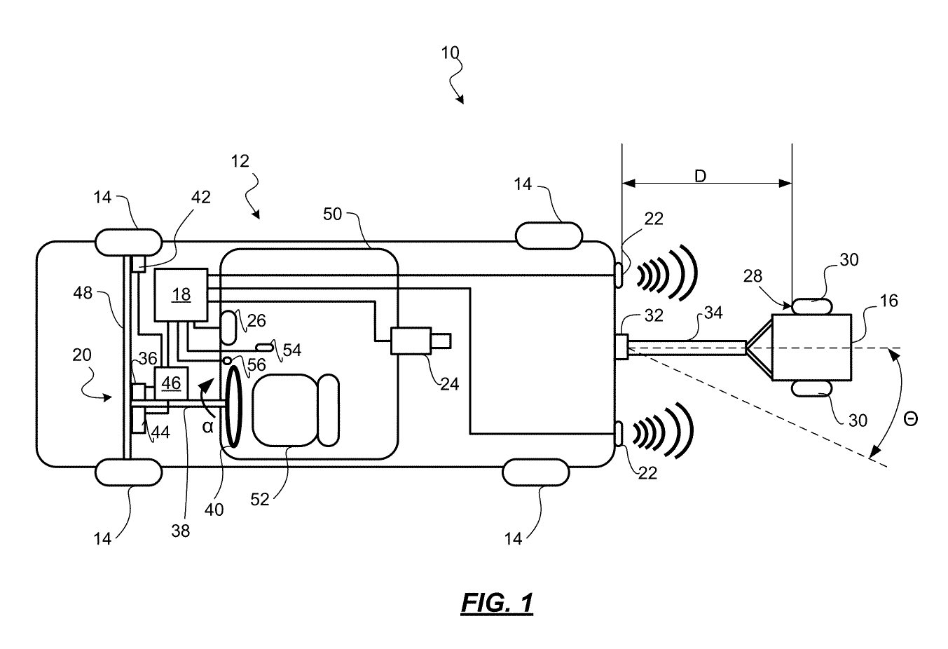

Referring now to FIG. 1, an exemplary embodiment is directed to a trailer reverse assist system 10 that is part of a vehicle 12. The trailer reverse assist system 10 is used to actively steer one or more road wheels 14 of the vehicle 12 while guiding the vehicle 12 coupled to a trailer 16 in a reverse direction. The trailer reverse assist system 10 adjusts a hand wheel angle (α) of the vehicle 12 based on a pitch angle (Θ) of the trailer 16. The trailer reverse assist system 10 may include a park assist controller 18 and an electronic power steering system 20 coupled to the park assist controller 18. It will be understood that the park assist controller 18 and the electronic power steering system 20 as described herein can be integrated together, further subdivided, or otherwise distributed within the vehicle 12.

The park assist controller 18 is coupled to at least one rear distance sensor 22. The one or more rear distance sensors 22 can include one or more of: an ultrasonic sensor, an infrared sensor, and a rear vision system. In the embodiment as shown in FIG. 1, the vehicle 12 includes a pair of rear distance sensors 22 and a rear-facing camera 24. The rear-facing camera 24 can be used as part of a rear vision system to identify items within a field of view of the rear-facing camera 24 and/or to display images on a display system 26 in communication with the park assist controller 18. The one or more rear distance sensors 22 provide distance input to the park assist controller 18 to determine a distance (“D”) between the vehicle 12 and a target location 28 of the trailer 16, such as a wheel 30 of the trailer 16. A relative position of the target location 28 of the trailer 16 can be tracked using the one or more rear distance sensors 22. Alternatively, a plurality of target locations 28 can be tracked, such as one or more wheels 30 of the trailer 16.

The trailer 16 may be coupled to a trailer hitch 32 of the vehicle 12 via a trailer coupling 34. The trailer coupling 34 may be substantially rigid such that changes to the hand wheel angle α of the vehicle 12 translate into changes in the pitch angle Θ of the trailer 16. This relationship can be seen as a modified version of an inverted pendulum control system, where the pitch angle Θ is a function of the hand wheel angle α. The park assist controller 18 can determine the pitch angle Θ of the trailer 16 relative to the vehicle 12 based on the distance “D”. The hand wheel angle α may be determined from a hand wheel angle sensor 36 coupled to a steering column 38 that is further coupled to a hand wheel 40 (e.g., a steering wheel). The hand wheel angle sensor 36, a vehicle speed sensor 42, and a power steering motor 44 may be coupled to a control module 46 of the electronic power steering system 20. The control module 46 communicates with the park assist controller 18 to exchange data associated with the trailer reverse assist system 10. The power steering motor 44 is controlled by the control module 46 to adjust the hand wheel angle α, which translates rotational movement of the hand wheel 40 through the steering column 38 and through an axle 48 to turn road wheels 14 coupled to the axle 48.

Within a passenger compartment 50 of the vehicle 12, a driver at a driver position 52 can steer and align the vehicle 12 and the trailer 16 while driving in a forward direction. When assistance is desired with driving the combined vehicle 12 and trailer 16 in a reverse direction, a transmission gear selector 54 is set to reverse and a trailer reverse assist control switch 56 is actuated to enable the trailer reverse assist system 10. The driver can control the vehicle speed and braking as well as manually override hand wheel angle commands of the trailer reverse assist system 10. From the driver position 52, the driver may also observe and/or modify an intended path of the trailer 16 as displayed on the display system 26.

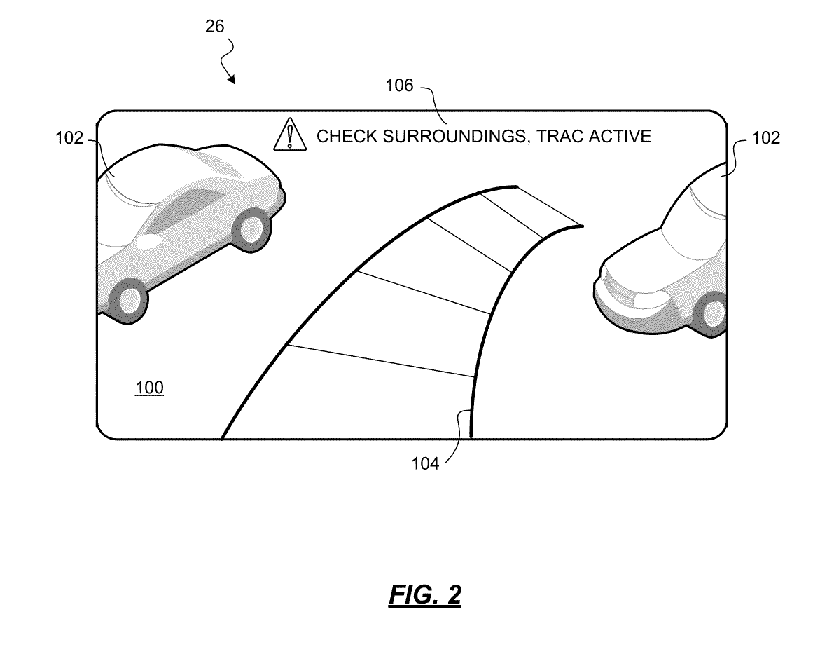

FIG. 2 is an illustration of the display system 26 for the trailer reverse assist system 10 of FIG. 1 according to an embodiment. In the example of FIG. 2, the display system 26 displays an image 100 which may be provided by the rear-facing camera 24 of FIG. 1. The image 100 can include potential obstacles 102. Image recognition logic in the park assist controller 18 of FIG. 1 may be used to further detect and highlight the potential obstacles 102 in the image 100; however, to reduce processing load, such additional processing need not be performed in embodiments.

To assist the driver in aligning and guiding the vehicle 12 and trailer 16 of FIG. 1, the display system 26 can overlay an intended path 104 of the trailer 16 on the image 100. The intended path 104 can be based on projecting a path that maintains an initial value of the hand wheel angle α or the pitch angle Θ substantially constant within a predetermined angle threshold, e.g., +/−5 degrees. The intended path 104 may be modified by the driver prior to or while advancing the vehicle 12 and trailer 16 in reverse. The display system 26 can also provide additional feedback by overlaying warning/status messages 106 on the image 100. The display system 26 can be implemented as a dashboard display, an active display rearview mirror, or a combination thereof. Accordingly, when the display system 26 is implemented as an active display rearview mirror, a reflected view of a rearview mirror also displays one or more overlays, such as the intended path 104 and/or warning/status messages 106. The display system 26 may also be configured to receive touch-sensitive input to control a variety of features such as zooming, panning, status updates, user preferences, and modification of the intended path 104.

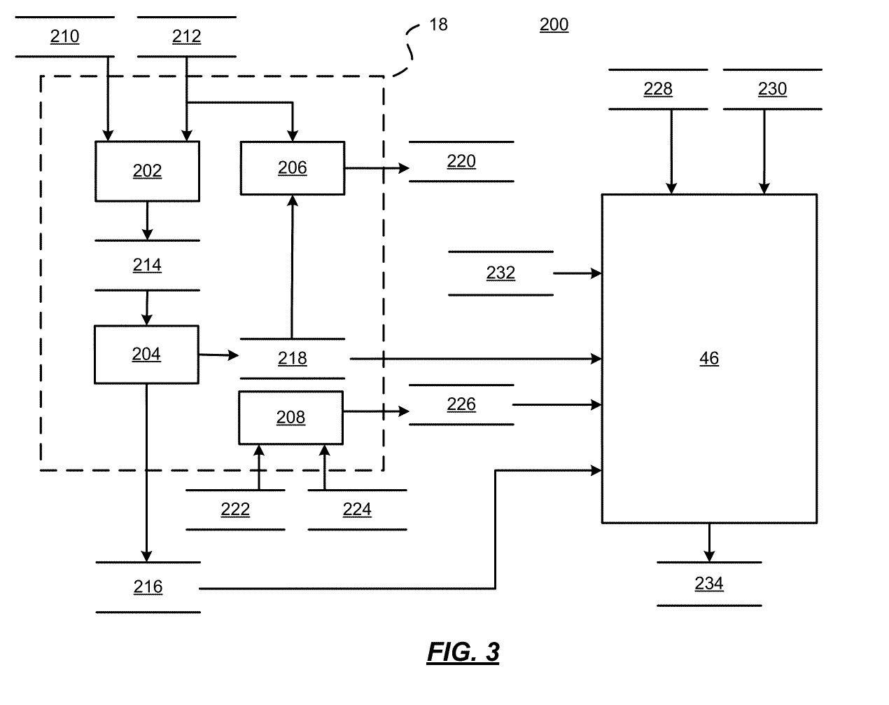

FIG. 3 is a dataflow diagram illustrating a control system 200 of the trailer reverse assist system 10 of FIG. 1. The control system 200 includes the park assist controller 18 and the control module 46 of FIG. 1 as further described herein according to an embodiment. The park assist controller 18 includes a distance determination module 202, a pitch angle determination module 204, a display system module 206, and a trailer reverse assist enable module 208. The distance determination module 202 receives a distance input 210 from the one or more rear distance sensors 22 of FIG. 1. The distance determination module 202 may also receive an image 212 captured by the rear-facing camera 24 of FIG. 1. The image 212 is also input into the display system module 206.

The distance determination module 202 determines a distance 214 (e.g., distance D of FIG. 1) between the vehicle 12 and the target location 28 of FIG. 1. The distance determination may be performed using techniques known in the art of distance measurement. An initial determination of the distance 214 may be used to establish a control reference point to be maintained as the vehicle 12 and trailer 16 are driven in reverse.

The pitch angle determination module 204 determines a pitch angle 216 (e.g., pitch angle Θ of FIG. 1) of the trailer 16 relative to the vehicle 12 based on the distance 214. For example, the pitch angle 216 can be trigonometrically determined based on an initial value of the distance 214 and changes to the distance 214 as the target location 28 of FIG. 1 moves laterally with respect to the one or more rear distance sensors 22 of FIG. 1. The pitch angle determination module 204 can also determine an intended path 218 (e.g., intended path 104 of FIG. 2) of the trailer 16. The intended path 218 of the trailer 16 may be substantially straight or at a fixed angle based on an initial alignment of the vehicle 12 relative to the trailer 16 upon enabling the trailer reverse assist system 10. The intended path 218 may also be provided to the display system module 206 to overlay the image 212 along with any warning/status messages 106 of FIG. 2 to output a display image 220 for the display system 26 of FIGS. 1 and 2.

The trailer reverse assist enable module 208 receives a selected value 222 of the transmission gear selector 54 and a state 224 of the trailer reverse assist control switch 56 of FIG. 1. An enable signal 226 is generated responsive to the state 224 of the trailer reverse assist control switch 56 being enabled and the transmission gear selector 54 having a selected value 222 of reverse. The enable signal 226 can be used to allow or prevent the electronic power steering system 20 of the trailer reverse assist system 10 from adjusting the hand wheel angle α of the vehicle 12.

In the example of FIG. 3, the control module 46 receives a hand wheel angle 228 (e.g., hand wheel angle α of FIG. 1) from the hand wheel angle sensor 36 of FIG. 1. The control module 46 also receives a vehicle speed 230 from vehicle speed sensor 42 of FIG. 1. The pitch angle 216, intended path 218, and enable signal 226 are also received at the control module 46 from the park assist controller 18. When the enable signal 226 indicates that trailer reverse assistance is enabled, the control module 46 determines a hand wheel command 234 to adjust the hand wheel angle 228 and align the pitch angle 216 of the trailer 16 of FIG. 1 with the intended path 218 of the trailer 16 based on the vehicle speed 230, the hand wheel angle 228, the pitch angle 216 of the trailer 16, and the intended path 218 of the trailer 16. The vehicle speed 230 may be used to determine how large of a corrective step to make per iteration. The hand wheel command 234 is output to the power steering motor 44 of the electronic power steering system 20 of FIG. 1.

The control module 46 updates the hand wheel command 234 such that a difference between the pitch angle 216 of the trailer 16 and the intended path 218 of the trailer 16 is maintained within a predetermined angle threshold 232. The predetermined angle threshold 232 may be stored in non-volatile memory as a configurable constant value of the system. In one embodiment, the intended path 218 is established based on an initial alignment of the vehicle 12 and trailer 16 when the enable signal 226 is initially asserted. The pitch angle 216 of the trailer 16 can determined based on a variation from the initial alignment, such that the control module 46 attempts to minimize an error signal difference between pitch angle 216 and the intended path 218 using, for example, a proportional-integral-derivative (PID) control feedback loop.

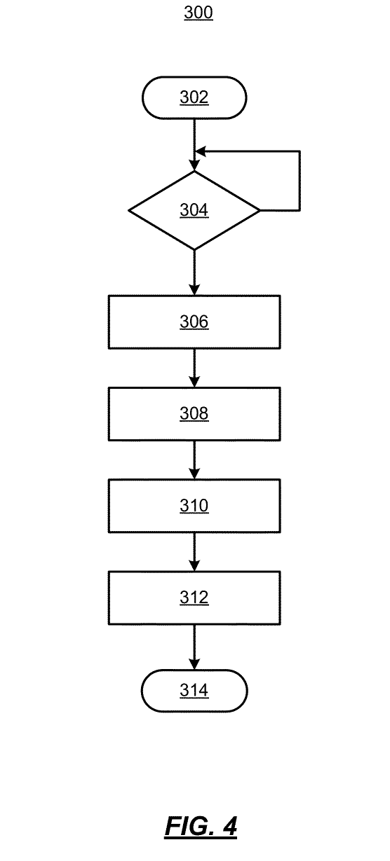

FIG. 4 is an exemplary process flow diagram illustrating a method 300 for providing the trailer reverse assist system 10 of FIG. 1 for vehicle 12 coupled to trailer 16 of FIG. 1. Accordingly, the method 300 is described in reference to FIGS. 1-4. Prior to initiating the method 300, a driver positions the vehicle 12 at an initial position, for example, by pulling the vehicle 12 forward. Method 300 begins at block 302 and proceeds to step 304.

At step 304, the park assist controller 18 determines a state of the transmission gear selector 54 and the trailer reverse assist control switch 56. If the transmission gear selector 54 is set to reverse and the trailer reverse assist control switch 56 is actuated, then the system is enabled and the method 300 may then proceed to step 306. Once enabled, the electronic power steering system 20 controls steering to correct for turning of the trailer 16 subject to driver override.

In step 306, the park assist controller 18 receives a distance input from at least one rear distance sensor 22. A distance “D” between the vehicle 12 and a target location 28 of the trailer 16 may be determined based on the distance input. The method 300 may then proceed to step 308

In step 308, the park assist controller 18 determines a pitch angle Θ of the trailer 16 relative to the vehicle 12 based on the distance input. The pitch angle Θ of the trailer 16 relative to the vehicle 12 may be determined based on the distance “D” between the vehicle 12 and the target location 28 of the trailer 16. The method 300 may then proceed to step 310.

In step 310, the pitch angle Θ of the trailer 16 and a hand wheel angle α of the vehicle 12 are provided to a control module 46 of electronic power steering system 20. The control module 46 can also receive a vehicle speed and an intended path of the trailer 16. Method 300 may then proceed to step 312.

In step 312, the control module 46 of the electronic power steering system 20 adjusts the hand wheel angle α of the vehicle 12 based on the pitch angle Θ of the trailer 16. The adjustment of the hand wheel angle α may also be based on the vehicle speed and the intended path of the trailer. The adjustment to the hand wheel angle α may align the pitch angle Θ of the trailer 16 with the intended path of the trailer 16. Based on the adjustments, a hand wheel command is output to a power steering motor 44 of the electronic power steering system 20. The hand wheel command may be updated while the trailer reverse assist system 10 is enabled such that a difference between the pitch angle Θ of the trailer 16 and the intended path of the trailer 16 is maintained within a predetermined angle threshold. As previously described, the intended path of the trailer 16 may be substantially straight or maintained at a fixed angle based on an initial alignment of the vehicle 12 relative to the trailer 16 upon enabling trailer reverse assistance, and the pitch angle Θ of the trailer 16 can be determined based on a variation from the initial alignment. Method 300 may then terminate at block 314.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A trailer reverse assist system for a vehicle coupled to a trailer, the trailer reverse assist system comprising:
a park assist controller configured to receive a distance input from at least one rear distance sensor, the park assist controller configured to determine a pitch angle of the trailer relative to the vehicle based on the distance input; and
an electronic power steering system coupled to the park assist controller, the electronic power steering system configured to adjust a hand wheel angle of the vehicle based on the pitch angle of the trailer.

2. The trailer reverse assist system of claim 1, wherein the park assist controller comprises a distance determination module configured to determine a distance between the vehicle and a target location of the trailer based on the distance input.

3. The trailer reverse assist system of claim 2, wherein the park assist controller further comprises a pitch angle determination module in communication with the distance determination module and configured to determine the pitch angle of the trailer relative to the vehicle based on the distance between the vehicle and the target location of the trailer.

4. The trailer reverse assist system of claim 3, wherein the target location of the trailer is a wheel of the trailer.

5. The trailer reverse assist system of claim 1, wherein the at least one rear distance sensor comprises one or more of: an ultrasonic sensor, an infrared sensor, and a rear vision system.

6. The trailer reverse assist system of claim 1, further comprising a control module configured to:
receive a vehicle speed, the hand wheel angle, the pitch angle of the trailer, and an intended path of the trailer;
determine a hand wheel command to adjust the hand wheel angle and align the pitch angle of the trailer with the intended path of the trailer based on the vehicle speed, the hand wheel angle, the pitch angle of the trailer, and the intended path of the trailer; and
output the hand wheel command to a power steering motor of the electronic power steering system.

7. The trailer reverse assist system of claim 6, wherein the control module is in communication with a trailer reverse assist control switch and a transmission gear selector, and the trailer reverse assist system is enabled responsive to a state of the trailer reverse assist control switch being enabled and the transmission gear selector being set to reverse.

8. The trailer reverse assist system of claim 6, further comprising a display system configured to display the intended path of the trailer, the display system comprising one or more of: an active display rearview mirror and a dashboard display.

9. The trailer reverse assist system of claim 6, wherein the control module updates the hand wheel command such that a difference between the pitch angle of the trailer and the intended path of the trailer is maintained within a predetermined angle threshold.

10. The trailer reverse assist system of claim 9, wherein the intended path of the trailer is a fixed angle based on an initial alignment of the vehicle relative to the trailer upon enabling the trailer reverse assist system, and the pitch angle of the trailer is further determined based on a variation from the initial alignment.

11. A method for trailer reverse assist for a vehicle coupled to a trailer, the method comprising:
receiving, at a park assist controller, a distance input from at least one rear distance sensor;
determining, by the park assist controller, a pitch angle of the trailer relative to the vehicle based on the distance input;
providing the pitch angle of the trailer and a hand wheel angle of the vehicle to an electronic power steering system; and
adjusting, by the electronic power steering system, the hand wheel angle of the vehicle based on the pitch angle of the trailer.

12. The method of claim 11, further comprising determining a distance between the vehicle and a target location of the trailer based on the distance input.

13. The method of claim 12, further comprising determining the pitch angle of the trailer relative to the vehicle based on the distance between the vehicle and the target location of the trailer.

14. The method of claim 13, wherein the target location of the trailer is a wheel of the trailer.

15. The method of claim 11, wherein the at least one rear distance sensor comprises one or more of: an ultrasonic sensor, an infrared sensor, and a rear vision system.

16. The method of claim 11, further comprising:
receiving a vehicle speed, the hand wheel angle, the pitch angle of the trailer, and an intended path of the trailer at a control module;
determining, by the control module, a hand wheel command to adjust the hand wheel angle and align the pitch angle of the trailer with the intended path of the trailer based on the vehicle speed, the hand wheel angle, the pitch angle of the trailer, and the intended path of the trailer; and
outputting the hand wheel command to a power steering motor of the electronic power steering system.

17. The method of claim 16, further comprising:
determining a state of a trailer reverse assist control switch and a transmission gear selector; and
performing the adjusting of the hand wheel angle based on the trailer reverse assist control switch being enabled and the transmission gear selector being set to reverse.

18. The method of claim 16, further comprising displaying the intended path of the trailer on a display system, the display system comprising one or more of: an active display rearview mirror and a dashboard display.

19. The method of claim 16, further comprising updating the hand wheel command such that a difference between the pitch angle of the trailer and the intended path of the trailer is maintained within a predetermined angle threshold.

20. The method of claim 19, wherein the intended path of the trailer is a fixed angle based on an initial alignment of the vehicle relative to the trailer upon enabling trailer reverse assistance, and the pitch angle of the trailer is further determined based on a variation from the initial alignment.
